(19) United States
(12) Patent Application Publication
(10) Pub. No.: US 2022/0311735 A1
(43) Pub. Date: Sep. 29, 2022

(54) CARRIER GRADE NETWORK ADDRESS TRANSLATION ARCHITECTURE AND IMPLEMENTATION

(71) Applicant: AT&T Intellectual Property I, L.P., Atlanta, GA (US)

(72) Inventors: Robert Sayko, Colts Neck, NJ (US); Avinash Lingala, Edison, NJ (US)

(21) Appl. No.: 17/213,070

(22) Filed: Mar. 25, 2021

(51) Int. Cl. H04L 29/12; H04L 12/741

(52) U.S. Cl. CPC H04L 61/2514; H04L 61/256; H04L 45/745; H04L 61/2517

(57) ABSTRACT

An example apparatus includes a first network interface to connect to a provider router in a core network, a second network to connect to an input/output (I/O) router in a local access network that includes a plurality of different endpoint devices, a routing block to determine a first set of data that is to be passed-through without receiving network address translation, and a processor, wherein the processor is to generate a plurality of virtual carrier grade network address translation (vCG-NAT) instances, wherein the plurality of vCG-NAT instances is to route a second set of data between the provider router and the I/O router, wherein the routing block is to route the second set of data to a correct vCG-NAT instance of the plurality of vCG-NAT instances based on routing information in the routing block.

The present disclosure relates generally to network architectures, and relates more particularly to an apparatus, method, and non-transitory computer readable medium for a lower cost and more scalable carrier grade network address translation (CG-NAT) architecture.

### BACKGROUND

Internet traffic has grown exponentially over time. Various technologies are used to route traffic across the globe. Internet traffic may assign Internet protocol (IP) addresses to route traffic from a source to a destination. An example of a protocol used to assign Internet protocol (IP) addresses is Internet protocol version 4 (IPv4). However, IPv4 addresses are becoming a scarce commodity as the Internet growth exceeds the number of addresses available.

### BRIEF DESCRIPTION OF THE DRAWINGS

The teachings of the present disclosure can be readily understood by considering the following detailed description in conjunction with the accompanying drawings, in which:

FIG. 1 illustrates an example network that uses a CG-NAT device of the present disclosure;

FIG. 2 illustrates a more detailed block diagram of the example CG-NAT device and how data is routed through the CG-NAT device of the present disclosure;

FIG. 3 illustrates a flowchart of an example method for routing data through a CG-NAT device, in accordance with the present disclosure; and

FIG. 4 depicts a high-level block diagram of a computing device or processing system specifically programmed to perform the functions described herein.

To facilitate understanding, similar reference numerals have been used, where possible, to designate elements that are common to the figures.

### DETAILED DESCRIPTION

The present disclosure broadly discloses an apparatus, method, and non-transitory computer readable medium for a lower cost and more scalable CG-NAT architecture. In one example, an apparatus includes a first network interface to connect to a provider router in a core network, a second network interface to connect to an input/output (I/O) router in a local access network that includes a plurality of different endpoint devices, a routing block to determine a first set of data that is to be passed-through without receiving network address translation and a second set of data that requires network address translation, and a processor, wherein the processor is to generate a plurality of virtual carrier grade network address translation (vCG-NAT) instances, wherein the plurality of vCG-NAT instances is to route a second set of data between the provider router and the I/O router, wherein the routing block is to route the second set of data to a correct vCG-NAT instance of the plurality of vCG-NAT instances based on routing information in the routing block.

In another example, a method performed by a processing system includes receiving a data packet from a provider router in a core network, determining that the data packet requires network address translation, determining a virtual carrier grade network address translation (vCG-NAT) instance associated with the data packet, performing network address translation on the data packet via the vCG-NAT, and transmitting the data packet that has received network address translation to an input/output (I/O) router in a local access network to forward the data packet to an endpoint device.

In another example, a non-transitory computer-readable medium may store instructions which, when executed by a processing system in a communications network, cause the processing system to perform operations. The operations may include receiving a data packet from a provider router in a core network, determining that the data packet requires network address translation, determining a virtual carrier grade network address translation (vCG-NAT) instance associated with the data packet, performing network address translation on the data packet via the vCG-NAT, and transmitting the data packet that has received network address translation to an input/output (I/O) router in a local access network to forward the data packet to an endpoint device.

As discussed above, IPv4 addresses are becoming a scarce commodity as the Internet growth exceeds the number of addresses available. CG-NAT may be used to bridge to the future use of Internet Protocol version 6 (IPv6). Internet service providers (ISPs) may be incentivized to deploy CG-NAT due to the ability to sell IPv4 addresses that are freed from the implementation of the CG-NAT architecture.

However, current CG-NAT network configurations may use a proprietary card in a service node where the network address translation takes place. The proprietary card has a physical limit to the number of ports to perform the network address translation. The physical limit to these proprietary cards may prevent the service node from performing the network address translation of thousands of IP addresses for end users. Currently, to increase capacity, additional proprietary cards must be purchased and installed in the router chassis. The proprietary cards can be expensive. As a result, scaling up the CG-NAT architecture with currently used methods may be expensive and limited by the amount of space available in the router chassis.

Examples of the present disclosure may provide a CG-NAT device that sits between the core network and the local access network. The CG-NAT device may be a combination of a carrier grade network (CGN) leaf, a virtual application, and a management switch. The CG-NAT device may create any number of virtual CG-NAT instances to perform IP address translation.

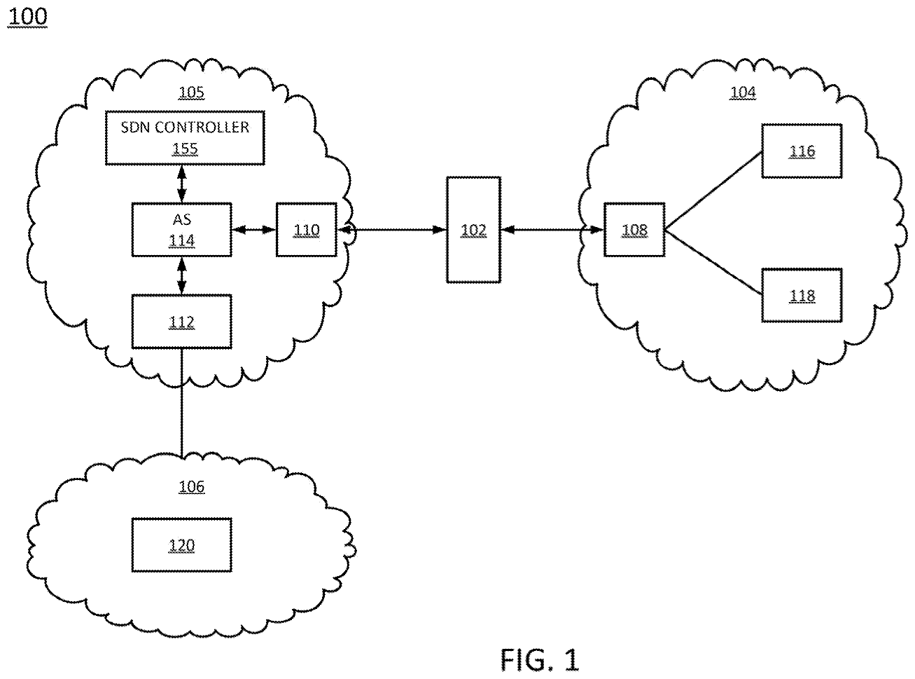

Thus, the CG-NAT device of the present disclosure may be implemented at a much lower cost as the CG-NAT device of the present disclosure does not require proprietary line cards to be installed. In addition, the CG-NAT device of the present disclosure can be easily scaled to larger network architectures. The CG-NAT device of the present disclosure can be easily deployed between the core network and the local access network with little to no modifications of existing network elements and/or devices. These and other aspects of the present disclosure are discussed in greater detail below in connection with the examples of FIGS. 1-4.

To aid in understanding the present disclosure, FIG. 1 illustrates a block diagram depicting one example of a communications network or system 100 for performing or enabling the steps, functions, operations, and/or features described herein. The system 100 may include any number of interconnected networks which may use the same or different communication technologies. As illustrated in FIG. 1, system 100 may include a network 105, e.g., a core telecommunication network. In one example, the network 105 may comprise a backbone network, or transport network, such as an Internet Protocol (IP)/multi-protocol label switching (MPLS) network, where label switched paths (LSPs) can be assigned for routing Transmission Control Protocol (TCP)/IP packets, User Datagram Protocol (UDP)/IP packets, and other types of protocol data units (PDUs) (broadly “traffic”). However, it will be appreciated that the present disclosure is equally applicable to other types of data units and network protocols. For instance, the network 105 may alternatively or additional comprise components of a cellular core network, such as a Public Land Mobile Network (PLMN), a General Packet Radio Service (GPRS) core network, and/or an evolved packet core (EPC) network, an Internet Protocol Multimedia Subsystem (IMS) network, a Voice over Internet Protocol (VoIP) network, multi-cast networks, virtual private networks (VPNs), and so forth. In one example, the network 105 uses a network function virtualization infrastructure (NFVI), e.g., servers in a data center or data centers that are available as host devices to host virtual machines (VMs) comprising virtual network functions (VNFs). In other words, at least a portion of the network 105 may incorporate software-defined network (SDN) components.

In this regard, it should be noted that as referred to herein, “traffic” may comprise all or a portion of a transmission, e.g., a sequence or flow, comprising one or more packets, segments, datagrams, frames, cells, PDUs, service data unit, bursts, and so forth. The particular terminology or types of data units involved may vary depending upon the underlying network technology. Thus, the term “traffic” is intended to refer to any quantity of data to be sent from a source to a destination through one or more networks.

In one example, the network 105 may be in communication with networks 104 and networks 106. Networks 104 and 106 may each comprise a wireless network (e.g., an Institute of Electrical and Electronics Engineers (IEEE) 802.11/Wi-Fi network and the like), a cellular access network (e.g., a Universal Terrestrial Radio Access Network (UTRAN) or an evolved UTRAN (eUTRAN), and the like), a circuit switched network (e.g., a public switched telephone network (PSTN)), a cable network, a digital subscriber line (DSL) network, a metropolitan area network (MAN), an Internet service provider (ISP) network, a peer network, and the like. In one example, the networks 104 and 106 may include different types of networks. In another example, the networks 104 and 106 may be the same type of network. The networks 104 and 106 may be controlled or operated by a same entity as that of network 105 or may be controlled or operated by one or more different entities. In one example, the networks 104 and 106 may comprise separate domains, e.g., separate routing domains as compared to the network 105. In one example, networks 104 and/or networks 106 may represent the Internet in general.

In one embodiment, the network 104 may be a local access network with an Input/Output (I/O) router 108. The I/O router 108 may be communicatively coupled to a plurality of endpoint devices 116 and 118. The endpoint devices 116 and 118 may be any type of endpoint device (e.g., a desktop computer, a laptop computer, a mobile telephone, a tablet computer, a set top box, a smart appliance, an Internet of Things (IoT) device, and the like). The I/O router 108 may be a router that aggregates IP traffic or data from a private side of the network 104 that includes the endpoint devices 116 and 118.

In one embodiment, the I/O router 108 may be assigned an Internet Protocol version 4 (IPv4) address that is shared by the endpoint devices 116 and 118 via private IP address and port assignments. The I/O router 108 may route data to a particular endpoint device 116 or 118 based on port numbers and a private IP address received from a CG-NAT device 102. However, the virtual CG-NAT (vCG-NAT) of the present disclosure may replace the routing function of the I/O router 108 and route directly to the endpoint device 116 and 118 via a mapping of the IP addresses and port numbers, as described in further details below.

In one embodiment, the network 106 may be a public network, e.g., the Internet. The public network 106 may include a server 120 that hosts a website. The endpoint devices 116 and 118 may exchange data with the website hosted by the server 120 via the CG-NAT device 102 of the present disclosure, as described in further details below. Although a single public network 106 and a single server 120 are illustrated in FIG. 1, it should be noted that any number of public networks and servers may be deployed and connected to the core network 105.

The CG-NAT device 102 of the present disclosure may be deployed between a provider router 110 of the core network 105 and the I/O router 108 to perform network address translations via the vCG-NAT instances. As noted above, the creation of the vCG-NAT instances via the CG-NAT device 102 of the present disclosure provides a more scalable and lower cost architecture for deploying CG-NAT and freeing up more IPv4 addresses that can be sold by Internet service providers. The CG-NAT device 102 can be deployed with little to no modification to the provider router 110 or the I/O router 108 that were previously directly connected to each other. As noted above, network address translation was previously performed using proprietary line cards that were installed in a router chassis of the I/O router 108.

In one example, network 105 may transport traffic to and from endpoint devices 116 and 118. For instance, the traffic may relate to communications such as voice telephone calls, video and other multimedia, text messaging, emails, and so forth between the endpoint devices 116 and 118 and the server 120 (or potentially other endpoint devices (not shown)).

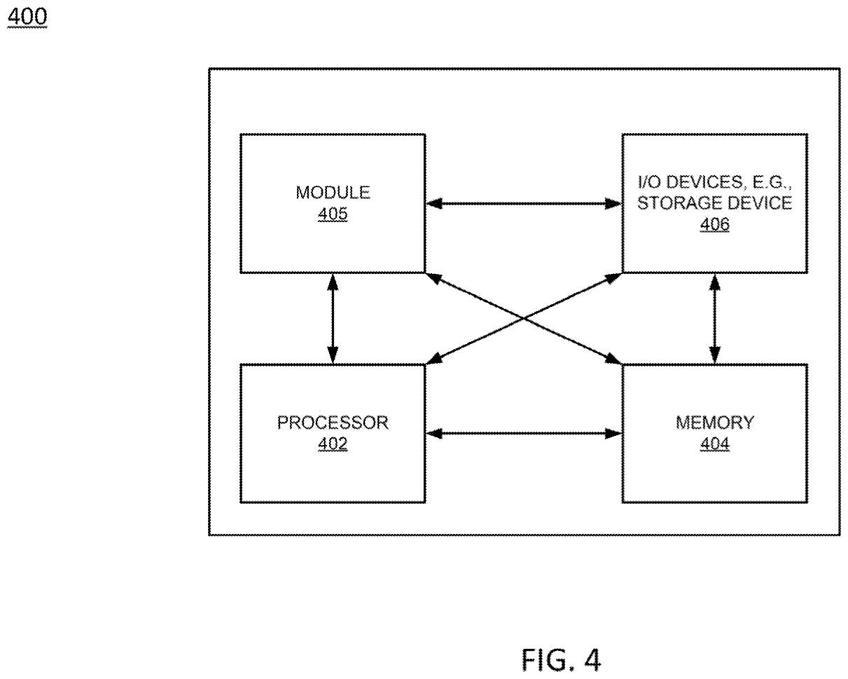

As further illustrated in FIG. 1, network 105 includes a software defined network (SDN) controller 155. In one example, the SDN controller 155 may comprise a computing system or server, such as computing system 400 depicted in FIG. 4, and may be configured to provide one or more operations or functions in connection with examples of the present disclosure for performing policy based routing via the CG-NAT device 102. In addition, it should be noted that as used herein, the terms “configure,” and “reconfigure” may refer to programming or loading a processing system with computer-readable/computer-executable instructions, code, and/or programs, e.g., in a distributed or non-distributed memory, which when executed by a processor, or processors, of the processing system within a same device or within distributed devices, may cause the processing system to perform various functions. Such terms may also encompass providing variables, data values, tables, objects, or other data structures or the like which may cause a processing system executing computer-readable instructions, code, and/or programs to function differently depending upon the values of the variables or other data structures that are provided. As referred to herein a “processing system” may comprise a computing device including one or more processors, or cores (e.g., a computing system as illustrated in FIG. 4 and discussed below) or multiple computing devices collectively configured to perform various steps, functions, and/or operations in accordance with the present disclosure.

In one example, an application server (AS) 114 that may perform various network control functions within the core network 105 may be controlled and managed by the SDN controller 155. For instance, in one example, SDN controller 155 is responsible for such functions as provisioning and releasing instantiations of virtual network functions (VNFs) to perform the functions of routers, switches, and other devices, provisioning routing tables and other operating parameters for the VNFs, and so forth. In one example, SDN controller 155 may maintain communications with VNFs via a number of control links which may comprise secure tunnels for signaling communications over an underling IP infrastructure of network 105. In other words, the control links may comprise virtual links multiplexed with transmission traffic and other data traversing network 105 and carried over a shared set of physical links. For ease of illustration the control links are omitted from FIG. 1. In one example, the SDN controller 155 may also comprise a virtual machine operating on a host device(s), or may comprise a dedicated device. For instance, SDN controller 155 may be collocated with one or more VNFs, or may be deployed in a different host device or at a different physical location.

The functions of SDN controller 155 may include the operation of the CG-NAT device 102. For example, the SDN controller 155 may download computer-executable/computer-readable instructions, code, and/or programs (broadly “configuration code”) for the CG-NAT device 102, which when executed by a processor of the CG-NAT device 102, may cause the CG-NAT device 102 to perform as a PE router, a switch, a network address translation device, and so forth. In one example, SDN controller 155 may download the configuration code to the CG-NAT device 102. In another example, SDN controller 155 may instruct the CG-NAT device 102 to load the configuration code previously stored on the CG-NAT device 102 and/or to retrieve the configuration code from another device in network 105 that may store the configuration code for one or more VNFs.

In addition, in one example, SDN controller 155 may represent a processing system comprising a plurality of controllers, e.g., a multi-layer SDN controller, one or more federated layer 0/physical layer SDN controllers, and so forth. For instance, a multi-layer SDN controller may be responsible for instantiating, tearing down, configuring, reconfiguring, and/or managing layer 2 and/or layer 3 VNFs (e.g., a network switch, a layer 3 switch and/or a router, etc.), whereas one or more layer 0 SDN controllers may be responsible for activating and deactivating optical networking components, for configuring and reconfiguring the optical networking components (e.g., to provide circuits/wavelength connections between various nodes or to be placed in idle mode), for receiving management and configuration information from such devices, for instructing optical devices at various nodes to engage in testing operations in accordance with the present disclosure, and so forth. In one example, the layer 0 SDN controller(s) may in turn be controlled by the multi-layer SDN controller. For instance, each layer 0 SDN controller may be assigned to nodes/optical components within a portion of the network 105. In addition, these various components may be co-located or distributed among a plurality of different dedicated computing devices or shared computing devices (e.g., NFVI) as described herein.

It should be noted that the system 100 has been simplified. In other words, the system 100 may be implemented in a different form than that illustrated in FIG. 1. For example, the system 100 may be expanded to include additional networks, such as a network operations center (NOC) network, and additional network elements (not shown) such as border elements, routers, switches, policy servers, security devices, gateways, a content distribution network (CDN) and the like, without altering the scope of the present disclosure. In addition, system 100 may be altered to omit various elements, substitute elements for devices that perform the same or similar functions and/or combine elements that are illustrated as separate devices. In still another example, SDN controller 155, the AS 114, and/or other network elements may comprise functions that are spread across several devices that operate collectively as a SDN controller, an edge device, etc. Thus, these and other modifications of the system 100 are all contemplated within the scope of the present disclosure.

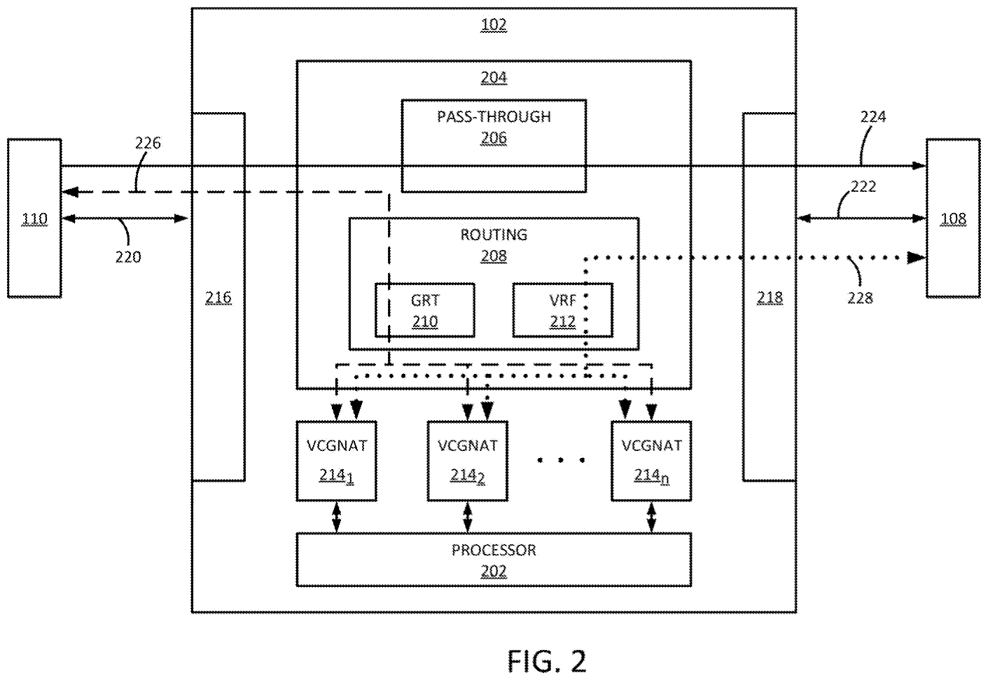

FIG. 2 illustrates a more detailed block diagram of the CG-NAT device 102 and how data is routed by the CG-NAT device 102 of the present disclosure. In one embodiment, the CG-NAT device 102 may include a processor 202 and a routing block 204. In one embodiment, the routing block 204 may include a pass-through portion 206 and routing instructions 208 (or broadly a routing portion with routing capability). In one embodiment, the routing block 204 may be referred to as a “CGN leaf” and perform functions similar to a provider edge router. The pass-through portion 206 may include one or more physical ports that may allow data to pass-through the CG-NAT device 102 without receiving any network address translation. For example, some endpoints 116 and 118 may be assigned a public routable IP address that may not require network address translation. Data that is sent to these public routable IP addresses may be passed-through the CG-NAT device 102 via the pass-through portion 206 without receiving any network address translation, or via the routing block 204.

In another example, data that includes a static IPv4 address may identified as data that may be passed-through the CG-NAT device 102. A line 224 represents an example path of data with a static IPv4 address that travels through the pass-through portion 206 of the routing block 204.

In one embodiment, processor 202 may be an x86 processor. The processor 202 may execute instructions that may generate and maintain operation of a plurality of vCG-NAT instances 214₁ to 214ₙ (hereinafter also referred to individually as a vCG-NAT instance 214 or collectively as vCG-NAT instances 214). In one embodiment, “virtualized” may be defined as execution of a computing system function or functions of a hardware system in a layer abstracted from the processor 202. In other words, each of the vCG-NAT instances 214 may appear to data or data packets as a physical hardware device that performs network address translation. However, the vCG-NAT instances 214 are executed in software under the control and assistance of the processor 202.

The vCG-NAT instances 214 may perform network address translation on the IP address of data packets. Each vCG-NAT instance 214 may be assigned to a particular IP address or a group of IP addresses. For example, public IP addresses with associated port numbers may be translated into a private IP address and associated port number, and vice versa. In one example, vCG-NAT instance 214₁ may be assigned to subscribers with a private IP address of 10.0.1.0/24, vCG-NAT instance 214₂ may be assigned to subscribers with a private IP address of 10.0.2.0/24, and so forth.

Within each vCG-NAT 214, the vCG-NAT 214 may provide address translation. For example, if a subscriber has a private IP address 10.0.0.1 with a source port range of 1-65000, then it may assign a public IP address of 12.12.12.1 and source-port range of 1024-2000. If a subscriber has a private IP address 10.0.0.2 with a source port-range of 1-65000, then it may assign a public IP address of 12.12.12.1 and source port range of 2001-3000, and so forth. As such, data packets transmitted (to and from) for these subscribers can be properly routed using the pertinent IP addresses and port numbers. These are only illustrated examples.

In one embodiment, the routing instructions 208 may include tables that direct data packets to a particular vCG-NAT instance 214 that is assigned to translate a range of IP addresses that includes the IP address of the data packet. The routing instructions 208 may include a global routing table (GRT) 210 and a virtual routing and forwarding (VRF) table 212. The GRT 210 may include a table of public IP addresses or Internet prefixes and the assigned vCG-NAT instance 214. In addition to the table of public IP addresses or Internet prefixes, the GRT 210 may include port number ranges associated with each of the public IP addresses. The GRT 210 may be used to direct data coming from the provider router 110 towards the I/O router 108. The VRF 212 may include a table of private IP addresses provided by the I/O router 108 and the assigned vCG-NAT instance 214. The VRF 212 may direct data coming from the I/O router 108 towards the provider router 110.

As noted above, the CG-NAT device 102 may be deployed between the provider router 110 and the I/O router 108. The CG-NAT device 102 may include a communication interface 216 and 218. The communication interface 216 may receive a physical connection 220 to the provider router 110. The communication interface 218 may receive a physical connection 222 to the I/O router 108.

The configuration of the provider router 110 and the I/O router 108 may have little to no changes. In other words, the CG-NAT device 102 may be a “plug-and-play” device. For example, the provider edge router 110 may continue to forward data believing that the data is being forwarded to the I/O router 108. The I/O router 108 may continue to forward data believing the data is being forwarded to the provider router 110. However, the data may be intercepted by the CG-NAT device 102. The CG-NAT device 102 may allow the data to pass-through or perform network address translation via the vCG-NAT instances 214.

In one embodiment, the CG-NAT device 102 may route the data to the assigned vCG-NAT instances 214 based on the source IP address of the data using the GRT 210 or the VRF 212, as described above. FIG. 2 illustrates an example path 226 of data that travels from the provider router 110. For example, the CG-NAT device 102 may read the IP address of the data and determine that the IP address is not a static IP address that can pass-through the CG-NAT device 102. As a result, the data may be routed with the assistance of the GRT 210 in the routing instructions 208.

The GRT 210 may direct the data to the correct vCG-NAT instance 214 based on the IP address and the assigned vCG-NAT instance 214 listed in the GRT 210. The assigned vCG-NAT instances 214 may perform network address translation. For example, the public IP address of the I/O router 108 and associated port number associated with the packet may be translated into a private IP address and port number from the information contained in the data. The CG-NAT device 102 may then transmit the data that has received the network address translation to the I/O router 108, which may then forward the data to the appropriate endpoint device 116 or 118 illustrated in FIG. 1.

FIG. 2 illustrates an example path 228 of data that travels from the I/O router 108 to the provider router 110. For example, the CG-NAT device 102 may read the IP address of the data and determine that the IP address is not a static IP address that can pass-through the CG-NAT device 102. As a result, the data may be routed with the assistance of the VRF 212 in the routing instructions 208.

The VRF 212 may direct the data to the correct vCG-NAT instance 214 based on the IP address and the assigned vCG-NAT instance 214 listed in the VRF 212. The assigned vCG-NAT instances 214 may perform network address translation. For example, the private IP address of a destination may be translated into a public IP address associated with a website hosted by the server 120. The CG-NAT device 102 may then transmit the data that has received the network address translation to the provider router 110, which may then forward the data to the appropriate server 120 illustrated in FIG. 1.

In one embodiment, as more capacity for network address translation is needed, the processor 202 may generate additional vCG-NAT instances 214. For example, if a new IP address is assigned for network address translation and the existing vCG-NAT instances 214 have no remaining capacity, the processor 202 may generate a new vCG-NAT instance 214 to handle the network address translation of the new IP address. The GRT 210 or the VRF 212 may be updated with a corresponding entry for the new IP address and the new vCG-NAT instance 214 that is assigned to the new IP address.

The only limit to the number of vCG-NAT instances 214 that can be created by the processor 202 is the processing power of the processor 202 and an amount of memory in the CG-NAT device 102. As a result, the CG-NAT architecture can be easily scaled at a much lower cost using the CG-NAT device 102 of the present disclosure. It should be noted that in one embodiment the CG-NAT device 102 can be deployed external to the networks 104 and 105. Alternatively, in one embodiment the CG-NAT device 102 can be deployed internal to either network 104 or network 105.

In one embodiment, the SDN controller 155 may provide the processor 202 information on an initial start-up of the CG-NAT device 102 after the CG-NAT device 102 is deployed. For example, the SDN controller 155 may provide the CG-NAT device 102 with the assigned IP addresses and port assignments for data that is transmitted between the provider router 110 and the I/O router 108. The processor 202 may take the information to generate a desired number of vCG-NAT instances 214 to perform the network address translation. The GRT 210 and the VRF 212 may be generated with the IP address ranges and port assignments and the vCG-NAT instances 214 that are assigned to each one of the IP address ranges and port assignments.

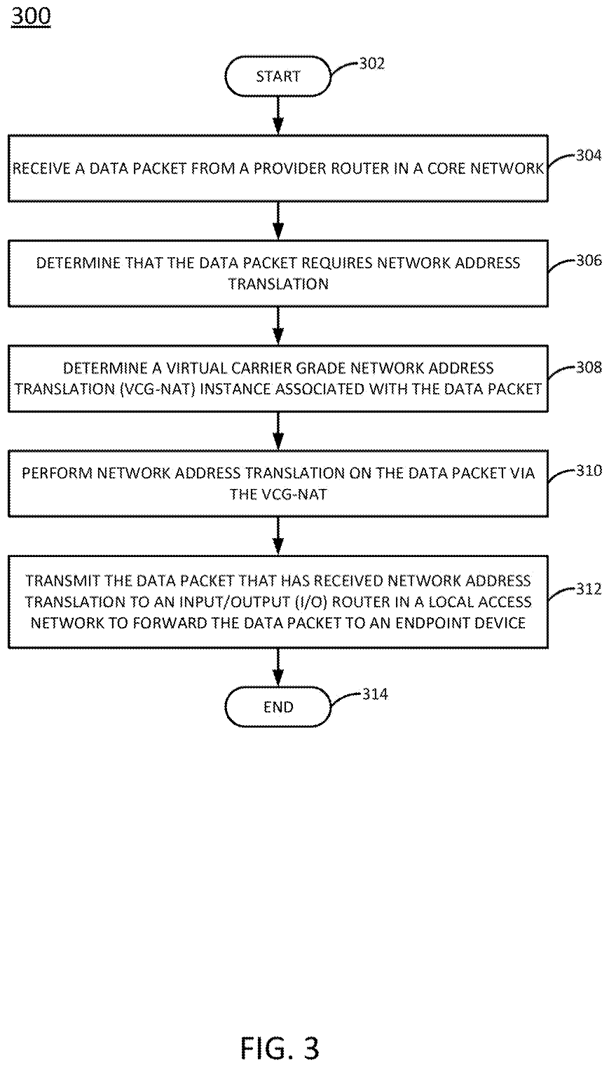

FIG. 3 illustrates a flowchart of an example method 300 for routing data through a CG-NAT device, in accordance with the present disclosure. In one example, steps, functions and/or operations of the method 300 may be performed by a device as illustrated in FIG. 1, e.g., AS 114 or any one or more components thereof. In one example, the steps, functions, or operations of method 300 may be performed by a computing device or system 400, and/or a processing system 402 as described in connection with FIG. 4 below. For instance, the computing device 400 may represent at least a portion of the AS 114 or any other hardware devices in accordance with the present disclosure. For illustrative purposes, the method 300 is described in greater detail below in connection with an example performed by a processing system, such as processing system 402.

The method 300 begins in step 302 and proceeds to step 304. In step 304, the processing system may receive a data packet from a provider router in a core network. The data packet may have a public IP address that is associated with an I/O router that services a plurality of different endpoint devices in a local access network. The public IP address may be an assigned IPv4 address. It should be noted that the data packet may also be associated with a port number in addition to the public IP address that is associated with the I/O router.

At step 306, the processing system may determine that the data packet requires network address translation. For example, as noted in the step 304, the IP address of the data packet may be an assigned IPv4 address. However, if the IP address was a static IP address, then the data packet may not require network address translation. Thus, data packets with static IP addresses may be passed-through without receiving any network address translation.

At step 308, the processing system may determine that a virtual carrier grade network address translation (vCG-NAT) instance is associated with the data packet. For example, a GRT table may be used to look up the public IP address of the data packet and find the assigned vCG-NAT instance from a plurality of different vCG-NAT instances generated by the processing system. The data packet may then be forwarded to the assigned vCG-NAT instance.

At step 310, the processing system may perform network address translation on the data packet via the identified vCG-NAT. For example, the public IP address and a port number associated with the packet may be translated into a private IP address and port number associated with the destination endpoint device.

At step 312, the processing system may transmit the data packet that has received network address translation to an input/output (I/O) router in a local access network to forward the data packet to an endpoint device. The data packet may then be transmitted to the I/O router. The I/O router may forward the data packet to the appropriate endpoint device based on the private IP address and the port number.

In one embodiment, the method 300 may also be performed in the opposite direction. For example, the method 300 may receive a second data packet from the I/O router. The processing system may determine that the data packet requires network address translation. For example, the data packet may have an assigned IP address rather than a static IP address that can be passed through the CG-NAT device of the processing system.

The processing system may determine the pertinent vCG-NAT instance associated with the second data packet. The vCG-NAT instance that is assigned to the second data packet may be determined using a VRF table.

The assigned vCG-NAT may perform the network address translation on the second data packet. For example, the private IP address of the second data packet may be converted into a public IP address associated with a destination (e.g., a website hosted by a public server in the Internet). The second data packet may then be transmitted to the provider router in the core network, which may then forward the second data packet to the destination server that hosts the web site that is intended to receive the second data packet.

In one embodiment, the method 300 may also generate new vCG-NAT instances if a new IP address is received and the existing vCG-NATs do not have capacity to accept another IP address. When no capacity is available, the CG-NAT device of the processing system may generate a new vCG-NAT instance. The new vCG-NAT instance may be assigned to the new IP address. The GRT and/or the VRF table may be updated accordingly. The method 300 may end in step 314.

It should be noted that the method 300 may be expanded to include additional steps or may be modified to include additional operations with respect to the steps outlined above. In addition, although not specifically specified, one or more steps, functions, or operations of the method 300 may include a storing, displaying, and/or outputting step as required for a particular application. In other words, any data, records, fields, and/or intermediate results discussed in the method can be stored, displayed, and/or outputted either on the device executing the method or to another device, as required for a particular application. Furthermore, steps, blocks, functions or operations in FIG. 3 that recite a determining operation or involve a decision do not necessarily require that both branches of the determining operation be practiced. In other words, one of the branches of the determining operation can be deemed as an optional step. Furthermore, steps, blocks, functions or operations of the above described method can be combined, separated, and/or performed in a different order from that described above, without departing from the examples of the present disclosure.

FIG. 4 depicts a high-level block diagram of a computing device or processing system specifically programmed to perform the functions described herein. As depicted in FIG. 4, the processing system 400 comprises one or more hardware processor elements 402 (e.g., a central processing unit (CPU), a microprocessor, or a multi-core processor), a memory 404 (e.g., random access memory (RAM) and/or read only memory (ROM)), a module 405 for routing data through a CG-NAT device, and various input/output devices 406 (e.g., storage devices, including but not limited to, a tape drive, a floppy drive, a hard disk drive or a compact disk drive, a receiver, a transmitter, a speaker, a display, a speech synthesizer, an output port, an input port and a user input device (such as a keyboard, a keypad, a mouse, a microphone and the like)). Although only one processor element is shown, it should be noted that the computing device may employ a plurality of processor elements. Furthermore, although only one computing device is shown in the figure, if the method 300 as discussed above is implemented in a distributed or parallel manner for a particular illustrative example, i.e., the steps of the above method 300 or the entire method 300 is implemented across multiple or parallel computing devices, e.g., a processing system, then the computing device of this figure is intended to represent each of those multiple computing devices.

Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented. The hardware processor 402 can also be configured or programmed to cause other devices to perform one or more operations as discussed above. In other words, the hardware processor 402 may serve the function of a central controller directing other devices to perform the one or more operations as discussed above.

It should be noted that the present disclosure can be implemented in software and/or in a combination of software and hardware, e.g., using application specific integrated circuits (ASIC), a programmable gate array (PGA) including a Field PGA, or a state machine deployed on a hardware device, a computing device or any other hardware equivalents, e.g., computer readable instructions pertaining to the method discussed above can be used to configure a hardware processor to perform the steps, functions and/or operations of the above disclosed method 300. In one example, instructions and data for the present module or process 405 for routing data through a CG-NAT device (e.g., a software program comprising computer-executable instructions) can be loaded into memory 404 and executed by hardware processor element 402 to implement the steps, functions, or operations as discussed above in connection with the illustrative method 300. Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method can be perceived as a programmed processor or a specialized processor. As such, the present module 405 for routing data through a CG-NAT device (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette, and the like. Furthermore, a “tangible” computer-readable storage device or medium comprises a physical device, a hardware device, or a device that is discernible by the touch. More specifically, the computer-readable storage device may comprise any physical devices that provide the ability to store information such as data and/or instructions to be accessed by a processor or a computing device such as a computer or an application server.

While various examples have been described above, it should be understood that they have been presented by way of illustration only, and not a limitation. Thus, the breadth and scope of any aspect of the present disclosure should not be limited by any of the above-described examples, but should be defined only in accordance with the following claims and their equivalents.

What is claimed is:

1. An apparatus comprising:
a first network interface to connect to a provider router in a communication network;
a second network interface to connect to an input/output router in a local access network that includes a plurality of different endpoint devices;
a routing block to determine a first set of data that is to be passed-through without receiving network address translation and a second set of data that requires network address translation; and
a processor, wherein the processor is to generate a plurality of virtual carrier grade network address translation instances, wherein the plurality of virtual carrier grade network address translation instances is to route the second set of data between the provider router and the input/output router, wherein the routing block is to route the second set of data to a corresponding virtual carrier grade network address translation instance of the plurality of virtual carrier grade network address translation instances based on routing information in the routing block.

2. The apparatus of claim 1, wherein the routing block comprises a pass-through block where the first set of data is routed without receiving network address translation.

3. The apparatus of claim 1, wherein the routing information comprises a global routing table to route data from the provider router to one of the plurality of virtual carrier grade network address translation instances based on a destination internet protocol address and a port number.

4. The apparatus of claim 1, wherein the routing information comprises a virtual routing and forwarding table to route data from the I/O router to one of the plurality of virtual carrier grade network address translation instances based on a public internet protocol address.

5. The apparatus of claim 1, wherein the processor is to generate new virtual carrier grade network address translation instance when a capacity limit of the plurality of virtual carrier grade network address translation instances is reached.

6. The apparatus of claim 5, wherein the routing information is updated to add a new Internet protocol address that is assigned to the new virtual carrier grade network address translation instance.

7. A method comprising:
receiving, by a processing system comprising at least one processor, a data packet from a provider router in a communication network;
determining, by the processing system, that the data packet requires network address translation;
determining, by the processing system, a first virtual carrier grade network address translation instance associated with the data packet from a plurality of virtual carrier grade network address translation instances;
performing, by the processing system, network address translation on the data packet via the virtual carrier grade network address translation instance; and
transmitting, by the processing system, the data packet that has received network address translation to an input/output router in a local access network to forward the data packet to an endpoint device.

8. The method of claim 7, further comprising:
receiving, by the processing system, a second data packet from the input/output router;
determining, by the processing system, that the second data packet requires network address translation;
determining, by the processing system, a second virtual carrier grade network address translation instance associated with the second data packet from the plurality of virtual carrier grade network address translation instances;
performing, by the processing system, network address translation on the second data packet via the second virtual carrier grade network address translation instance; and
transmitting, by the processing system, the second data packet that has received network address translation to the provider router in the communication network.

9. The method of claim 8, wherein the determining the second virtual carrier grade network address translation instance associated with the second data packet comprises:
looking up a public internet protocol address associated with the second data packet in a global routing table stored in a memory of the processing system.

10. The method of claim 8, wherein the performing the network address translation comprises converting a private internet protocol address into a public internet protocol address associated with a destination.

11. The method of claim 7, wherein a third data packet is passed-through if the third data packet is determined to not need network address translation.

12. The method of claim 11, wherein the third data packet is determined to not need network address translation when the third data packet includes a static internet protocol version 4 address.

13. The method of claim 7, wherein the determining the virtual carrier grade network address translation instance associated with the data packet, comprises:
looking up a private internet protocol address and a port number associated with the data packet in a virtual routing and forwarding table in a memory of the processing system.

14. The method of claim 7, wherein the performing the network address translation comprises converting a public internet protocol address associated with the input/output router and a port number associated with the data packet into a private internet protocol address and a port number associated with an endpoint device communicatively coupled to the input/output router.

15. The method of claim 7, further comprising:
receiving, by the processing system, a second data packet from the provider router;
determining, by the processing system, that the second data packet is not associated with any one of the plurality of virtual carrier grade network address translation instances and that the plurality of virtual carrier grade network address translation instances do not have available capacity to perform network address translation;
generating, by the processing system, a new virtual carrier grade network address translation instance for the second data packet.

16. The method of claim 15, further comprising:
updating, by the processing system, a global routing table to associate the new virtual carrier grade network address translation instance with a public internet protocol address associated with the second data packet.

17. A non-transitory computer-readable medium storing instructions which, when executed by a processing system including at least one processor, cause the processing system to perform operations, the operations comprising:
receiving a data packet from a provider router in a communication network;
determining that the data packet requires network address translation;
determining a first virtual carrier grade network address translation instance associated with the data packet from a plurality of virtual carrier grade network address translation instances;
performing network address translation on the data packet via the first virtual carrier grade network address translation instance; and
transmitting the data packet that has received network address translation to an input/output router in a local access network to forward the data packet to an endpoint device.

18. The non-transitory computer-readable medium of claim 17, the operations further comprising:
receiving a second data packet from the input/output router;
determining that the second data packet requires network address translation;
determining a second virtual carrier grade network address translation instance associated with the second data packet from the plurality of virtual carrier grade network address translation instances;
performing network address translation on the second data packet via the second virtual carrier grade network address translation instance; and
transmitting the second data packet that has received network address translation to the provider router in the communication network.

19. The non-transitory computer-readable medium of claim 17, the operations further comprising:
receiving a second data packet from the provider router;
determining that second data packet is not associated with any one of the plurality of virtual carrier grade network address translation instances and that the plurality of virtual carrier grade network address translation instances do not have available capacity to perform network address translation; and
generating, a new virtual carrier grade network address translation instance for the second data packet.

20. The non-transitory computer-readable medium of claim 19, the operations further comprising:
updating a global routing table to associate the new virtual carrier grade network address translation instance with a public internet protocol address associated with the second data packet.
